(19) United States
(12) Patent Application Publication
(10) Pub. No.: US 2026/0319164 A1
(43) Pub. Date: Oct. 15, 2026

(54) LIGHTING DEVICE AND DISPLAY DEVICE

(71) Applicant: Sharp Display Technology Corporation, Kameyama City (JP)

(72) Inventor: Hirofumi MIYAMOTO, Kameyama City (JP)

(21) Appl. No.: 19/466,698

(22) Filed: Feb. 2, 2026

(30) Foreign Application Priority Data
Feb. 4, 2025 (JP) 2025-016809

(51) Int. Cl. F21V 8/00

(52) U.S. Cl. CPC G02B 6/0091

(57) ABSTRACT

A lighting device includes a light source member including a light source and a light source substrate on which the light source is mounted, a light guide plate having side surfaces including a light entering surface through which light from the light source enters and that is opposed to a light emitting surface of the light source, and a connection member that connects the light guide plate and the light source member in a direction that the light entering surface and the light emitting surface are arranged. The connection member is made of material that shrinks under a predefined condition.

### CROSS-REFERENCE TO RELATED APPLICATION

This application claims priority from Japanese patent application No. 2025-016809 filed on Feb. 4, 2025. The entire contents of the priority application are incorporated herein by reference.

### TECHNICAL FIELD

The technology described herein relates to a lighting device and a display device.

### BACKGROUND

There has been known a one-edge-lit type backlight as a lighting device of a liquid crystal display device. Such an edge-lit type backlight includes a light source on an edge portion of a back surface of a liquid crystal panel. The backlight includes a light guide plate that has a light entering side surface that faces a light emitting surface of the light source. As a distance between the light entering side surface and the light emitting surface becomes shorter, the light entrance efficiency of light from the light emitting surface tends to increase and is highest when the distance is zero. On the other hand, the light guide plate may expand and shrink repeatedly due to the change of environment temperature and the position of the light entering side surface may be changed. When it occurs, the amount of light exiting from the backlight may be reduced and luminance unevenness may be caused in the backlight.

In this respect, there has been a backlight that includes a light source FPC (flexible printed circuit board) having LEDs thereon. The light source FPC includes LED mounting sections where the LEDs are mounted and holes around the LED mounting sections. Accordingly, the LED mounting sections are away from non-mounting sections having no LEDs and the LED mounting sections are configured to be slightly movable. Therefore, even if the light guide plate may expand and shrink repeatedly and the light entering side surface may be moved, the LED mounting sections also move according to the movement of the light entering side surface and the contact between the light emitting surfaces of the LEDs and the light entering side surface of the light guide plate is likely to be maintained.

However, with the LED mounting sections having the particular form as described above, the configuration of the light source FPC becomes complicated.

### SUMMARY

The technology described herein was made in view of the above circumstances. An object is to provide a lighting device and a display device that suppress luminance unevenness easily and surely.

A lighting device of this disclosure includes a light source member including a light source and a light source substrate on which the light source is mounted, a light guide plate having side surfaces including a light entering surface through which light from the light source enters and that is opposed to a light emitting surface of the light source, and a connection member that connects the light guide plate and the light source member in a direction that the light entering surface and the light emitting surface are arranged. The connection member is made of material that shrinks under a predefined condition.

According to the technology described herein, a distance between a light source and a light entering surface of a light guide plate can be controlled easily and surely.

### BRIEF DESCRIPTION OF THE DRAWINGS

FIG. 1 is an exploded perspective view of a liquid crystal display device according to a first embodiment.

FIG. 2 is a plan view of a backlight unit.

FIG. 3 is a cross-sectional view of a portion of the liquid crystal display device along A-A line in FIG. 2.

FIG. 4 is a cross-sectional view of a portion of the liquid crystal display device before a connection member shrinks.

FIG. 5 is a cross-sectional view of the portion of the liquid crystal display device after the connection member shrinks.

FIG. 6 is a plan view of a backlight unit according to a second embodiment.

FIG. 7 is a cross-sectional view of a portion of a liquid crystal display device along B-B line in FIG. 6.

FIG. 8 is a cross-sectional view of a portion of the liquid crystal display device before a connection member shrinks.

FIG. 9 is a cross-sectional view of the portion of the liquid crystal display device after the connection member shrinks.

### DETAILED DESCRIPTION

Embodiments according to the present disclosure will be listed and described.

(1) A lighting device of this disclosure includes a light source member including a light source and a light source substrate on which the light source is mounted, a light guide plate having side surfaces including a light entering surface through which light from the light source enters and that is opposed to a light emitting surface of the light source, and a connection member that connects the light guide plate and the light source member in a direction that the light entering surface and the light emitting surface are arranged. The connection member is made of material that shrinks under a predefined condition.

The light entrance efficiency of the light guide plate improves as the distance between the light source and the light entering surface of the light guide plate is shorter and it is most preferable that the distance is zero. However, there may be variation in position of the light source mounted on the light source substrate during the production of the device. The light guide plate may expand and shrink repeatedly due to the change of the temperature of the environment where the lighting device is disposed and the distance between the light source and the light entering surface of the light guide plate may change. In the lighting device of this disclosure, the connection member connects the light guide plate and the light source member in the direction that the light entering surface and the light emitting surface are arranged. The connection member is made of material that shrinks under a predefined condition. Therefore, even with a gap being created between the light entering surface and the light emitting surface of the light source, the connection member shrinks under the predefined condition and the gap is reduced. Therefore, luminance unevenness is suppressed easily and surely in the lighting device of this disclosure.

(2) In the lighting device according to (1), the light guide plate may include two plate surfaces that are surrounded by the side surfaces and the two plate surfaces may include a light exiting surface through which the light entering through the light entering surface exits and an opposite plate surface that is an opposite surface of the light exiting surface. The light source substrate may have a mounting surface on which the light source is mounted and the mounting surface may be opposed to the opposite plate surface. The connection member may connect a portion of the opposite plate surface and a portion of the mounting surface of the light source substrate.

With such a configuration, even with a gap being created between the light entering surface of the light guide plate and the light emitting surface of the light source, the connection member, which connects the portion of the opposite plate surface and the portion of the mounting surface of the light source substrate, shrinks under the predefined condition and the light entering surface and the light emitting surface become closer to each other and the gap is reduced. Since the opposite plate surface of the light guide plate is opposed to the mounting surface of the light source substrate, the light entering surface and the light emitting surface that become closer to each other according to the shrinkage of the connection member are likely to be contacted with each other closely. Therefore, luminance unevenness is suppressed in the lighting device.

(3) In the lighting device according to (1), the light guide plate may include a light exiting surface through which the light entering through the light entering surface exits and the light exiting surface may be a plate surface that is surrounded by the side surfaces. The light source may have a bottom surface and a top surface that are adjacent to the light emitting surface and the bottom surface is on the light source substrate. The connection member may connect a portion of the light exiting surface and the top surface of the light source.

With such a configuration, even with a gap being created between the light entering surface of the light guide plate and the light emitting surface of the light source, the connection member, which connects the portion of the opposite plate surface and the portion of the mounting surface of the light source substrate, shrinks under the predefined condition and the light entering surface and the light emitting surface become closer to each other and the gap is reduced. Therefore, luminance unevenness is suppressed in the lighting device.

In the lighting device according to (3), the light exiting surface of the light guide plate may preferably extend on a same plane as the top surface.

The light exiting surface of the light guide plate and the top surface of the light source extend on the same plane surface. Therefore, according to the shrinkage of the connection member, the light entering surface and the light emitting surface are likely to be closely contacted with each other.

(5) In the lighting device according to any one of (1) to (4), the light source substrate may preferably be a flexible substrate.

Since the light source substrate is a flexible substrate, the light source substrate is warped according to the shrinkage of the connection member and the light entering surface and the light emitting surface can be closely contacted with each other

(6) In the lighting device according to any one of (1) to (5), the connection member may be made of heat shrink material, and the light entering surface of the light guide plate and the light emitting surface of the light source may be in contact with each other with shrinkage of the connection member that is heated to a predefined temperature or higher.

The connection member is made of heat shrink material. Therefore, even with the gap being created between the light entering surface of the light guide plate and the light emitting surface of the light source, the connection member shrinks when the temperature of the connection member reaches the predefined temperature or higher and the gap is reduced. Therefore, luminance unevenness is easily suppressed in the lighting device.

(7) A display device includes the lighting device according to any one of (1) to (6), and a display panel displaying an image with using the light from the lighting device.

According to the display device having such a configuration, luminance unevenness is suppressed in the lighting device that supplies light to the display panel and quality of the display device is maintained.

### First Embodiment

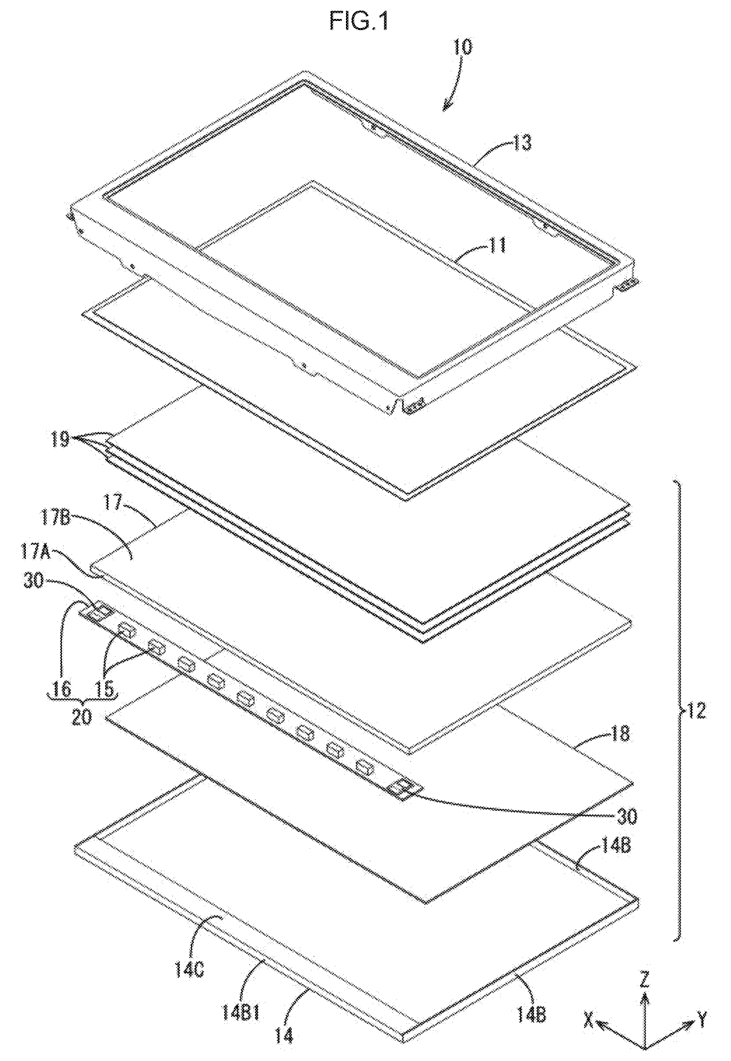

A general configuration of a first embodiment will be described with reference to FIGS. 1 to 3. A backlight unit 12 and a liquid crystal display device 10 including the backlight unit 12 will be described. The backlight unit 12 is one example of a lighting device. The backlight unit 12 supplies light to a liquid crystal panel 11 included in the liquid crystal display device 10. The liquid crystal panel 11 is one example of a display panel. The liquid crystal display device 10 is one example of a display device.

This disclosure is not limited to the examples and includes all modifications within and equivalent to the technical scope of the claims. In the following description, with respect to the same components, symbols are put on some of them and are not put on others. X-axes, Y-axes, and Z-axes may be present in the drawings. The axes in each drawing indicate directions that correspond to directions indicated by the respective axes in other drawings. With respect to the Z-axes, the liquid crystal panel 11 is disposed on a front side and the backlight unit 12 is disposed on the rear side.

As illustrated in FIG. 1, the liquid crystal display device 10 has a laterally long rectangular shape as a whole and includes the liquid crystal panel 11 and the backlight unit 12 that is disposed behind the liquid crystal panel 11. The liquid crystal panel 11 and the backlight unit 12 are held by a frame 13 with being overlapped in a front-rear direction. The liquid crystal panel 11 has a laterally long rectangular shape and disposed such that a display surface displaying an image faces the front side. The liquid crystal panel 11 includes a pair of transparent (highly light transmissive) substrates that are bonded with having a predefined gap therebetween. A liquid crystal layer is sealed between the glass substrates. Polarizing plates are attached to outer surfaces of the glass substrates, respectively.

As illustrated in FIG. 1, the frame 13 extends along a front-side peripheral edge portion of the liquid crystal panel 11 and is configured as a front side outer appearance of the liquid crystal display device 10. The frame 13 is made of metal having good rigidity such as stainless steel and aluminum material or resin having light blocking properties. A black tape member may be attached between the liquid crystal panel 11 and the frame 13 for fixing and blocking light. Instead of the frame 13, a tape member for blocking light may be attached.

Next, the backlight unit 12 will be described. As illustrated in FIG. 1, the backlight unit 12 supplies light to the liquid crystal panel 11 for displaying. The backlight unit 12 has a laterally long rectangular shape as a whole and has long edges and short edges extending along the X-axis direction and the Y-axis direction, respectively. The thickness direction of the backlight unit 12 matches the Z-axis direction. The backlight unit 12 includes a chassis 14, LEDs 15, an LED substrate 16, a light guide plate 17, a reflective sheet 18, optical sheets 19, and connection members 30. The LEDs 15 are one example of the light source. The LED substrate 16 is one example of a light source substrate. The light guide plate 17 guides light from the LEDs 15. The reflective sheet 18 is disposed behind the light guide plate 17. The optical sheets 19 are disposed between the light guide plate 17 and the liquid crystal panel 11. The backlight unit 12 is an edge-lit type backlight in which the light from the LEDs 15 enters the light guide plate 17 through only one of side surfaces of the light guide plate 17.

As illustrated in FIG. 1, the LEDs 15 are arranged along one direction. The direction in which the LEDs 15 are arranged matches the X-axis direction in each drawing. Nine LEDs 15 are arranged in FIG. 1 but the number of LEDs 15 may be other than nine. The LEDs 15 are arranged in a straight line at constant intervals in the X-axis direction. Each of the LEDs 15 includes an LED chip and a substrate. The substrate is bonded to the LED substrate 16. The chip is disposed on the substrate and sealed with a sealant. The LED chip of the LED 15 emits a single color of blue light. The sealant includes phosphor particles dispersed in the sealant. The phosphor particles in the sealant include yellow phosphor particles, green phosphor particles, and red phosphor particles. The LED 15 including the LED chip and the sealant emits white light as a whole.

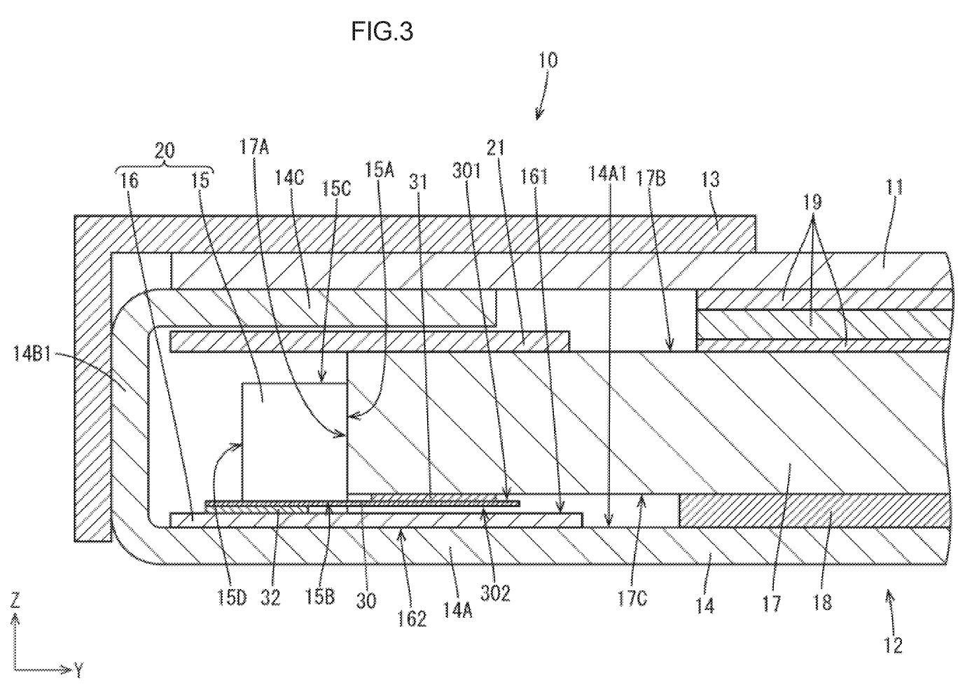

As illustrated in FIG. 3, the LEDs 15 include bottom surfaces 15B that are contacted with the LED substrate 16 and light emitting surfaces 15A adjacent to the bottom surfaces 15B. The LEDs 15 are side emitting LEDs. The light emitting surfaces 15A of the LEDs 15 extend parallel to the X-axis direction and the Z-axis direction and a normal direction to the light emitting surfaces 15A matches the Y-axis direction. An optical axis of each LED 15 is parallel to the Y-axis direction. The optical axis is referred to as an axis that is parallel to a light travel direction in which light rays having highest (peak) light emission intensity among the light rays emitted by the LED 15 propagate. The LEDs 15 have top surfaces 15C that are adjacent to the light emitting surfaces 15A and are opposite surfaces from the bottom surfaces 15B in the Z-axis direction.

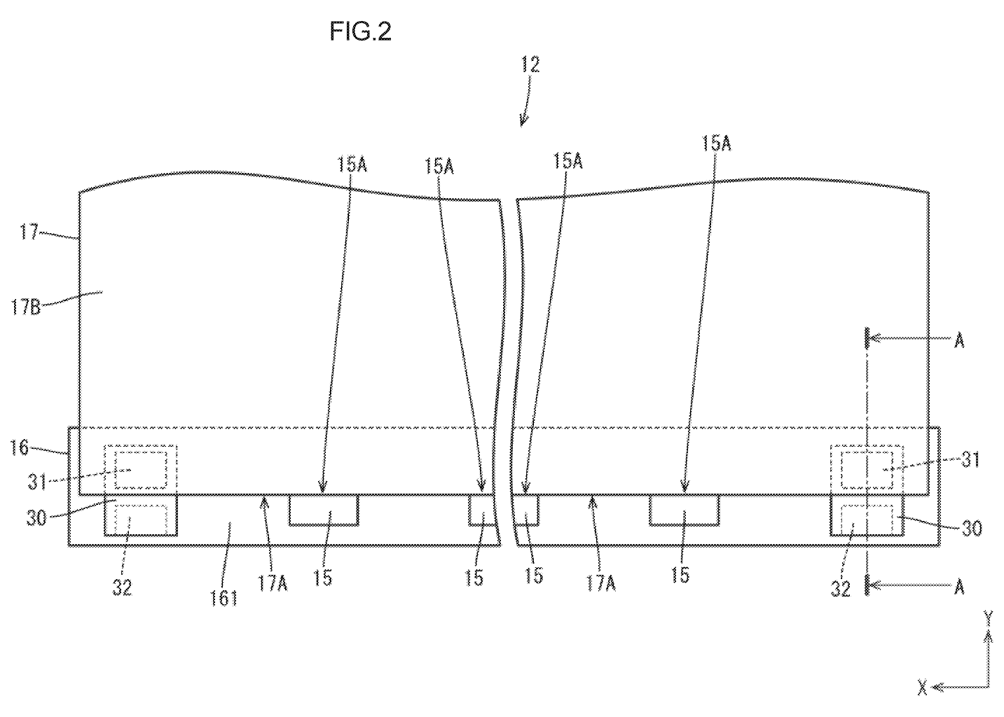

The LED substrate 16 is a flexible printed circuit (FPC) substrate that is a flexible film made of insulating material. The LED substrate 16 includes a substrate and traces of wiring of a metal foil such as copper disposed on the substrate. The substrate has insulating properties and is foldable and made of synthetic resin such as polyimide. As illustrated in FIGS. 1 and 2, the LED substrate 16 has an elongated belt plan view shape extending along the direction in which the LEDs 15 are arranged. As illustrated in FIG. 3, the LED substrate 16 is disposed such that the plate surface thereof is parallel to the surface of the light guide plate 17. The LEDs 15 are mounted on the LED substrate 16. One of the front and rear plate surfaces of the LED substrate 16 facing the front side is defined as a mounting surface 161 on which the LEDs 15 are mounted. Other one of the plate surfaces facing the rear side is defined as a rear surface 162 that is an opposite surface from the mounting surface 161. The mounting surface 161 of the LED substrate 16 faces the bottom surfaces 15B of the LEDs 15 and is contacted with the bottom surfaces 15B of the LEDs 15 and faces an opposite plate surface 17C of the light guide plate 17. The rear surface 162 of the LED substrate 16 faces a bottom portion front surface 14A1, which is a front surface of a bottom portion 14A of the chassis 14, and is contacted with the bottom portion front surface 14A1. The LEDs 15 and the LED substrate 16 are configured as a light source member 20. The chassis 14, the reflective sheet 18, and the optical sheets 19 are not illustrated in FIG. 2.

The light guide plate 17 is made of a transparent synthetic resin material having a refractive index sufficiently greater than that of the air. The synthetic resin used for the light guide plate 17 may be an acrylic resin such as PMMA and polycarbonate. As illustrated in FIG. 1, the light guide plate 17 has a plate shape having a surface that is parallel to a surface of the liquid crystal panel 11. The light guide plate 17 has long edges and short edges that are parallel to the X-axis direction and the Y-axis direction, respectively. The thickness direction of the light guide plate 17, which is a normal direction to the surface of the light guide plate 17, matches the Z-axis direction. The light guide plate 17 is disposed directly below the liquid crystal panel 11 and the optical sheets 19. The light guide plate 17 is disposed to overlap a display area of the liquid crystal panel 11.

As illustrated in FIGS. 2 and 3, one of side surfaces of the light guide plate 17 along the long edges is defined as a light entering surface 17A. The light entering surface 17A faces the light emitting surfaces 15A of the LEDs 15 and extends along the light emitting surfaces 15A. The light entering surface 17A is a laterally long surface that extends along the X-axis direction and the Z-axis direction. The elongated direction of the light entering surface 17A matches the X-axis direction (the direction in which the LEDs 15 are arranged) and the width direction matches the Z-axis direction. The normal direction to the light entering surface 17A matches the Y-axis direction. The light emitted through the light emitting surfaces 15A of the LEDs 15 directly enters the light guide plate 17 through the light entering surface 17A. Light entrance efficiency of light entering through the light entering surface 17A changes according to a distance between the light entering surface 17A and the light emitting surface 15A of the LED 15. As the distance becomes shorter, the light entrance efficiency tends to increase and becomes highest when the distance is zero. When the distance is zero, the light entering surface 17A is contacted with the light emitting surface 15A of the LED 15.

As illustrated in FIGS. 1 to 3, one of plate surfaces of the light guide plate 17 on the front side is defined as a light exiting surface 17B. The other one of the plate surfaces of the light guide plate 17 on the back side is defined as an opposite plate surface 17C. The light exiting surface 17B is opposed to the liquid crystal panel 11 and the optical sheets 19. The opposite plate surface 17C is opposed to the reflective sheet 18. The light exiting surface 17B and the opposite plate surface 17C are laterally long surfaces that extend along the X-axis direction and the Y-axis direction and the long sides and the short sides extend parallel to the X-axis direction and the Y-axis direction, respectively. The light emitted by the LEDs 15 toward the light guide plate 17 enter the light guide plate 17 through the light entering surface 17A and the light travels within the light guide plate 17 and is guided along the Z-axis direction toward the front side (a light exit side) and exits the light guide plate 17.

The connection member 30 is for connecting the light guide plate 17 and the light source member 20. In the first embodiment, as illustrated in FIGS. 1 and 2, the connection member 30 is mounted on each of two ends of the mounting surface 161 of the LED substrate 16 with respect to the X-axis direction. Details of the connection member 30 will be described later.

As illustrated in FIGS. 1 and 3, the reflective sheet 18 has plate surfaces parallel to the plate surfaces of the liquid crystal panel 11 and the light guide plate 17. The reflective sheet 18 is disposed to cover the opposite plate surface 17C of the light guide plate 17. The reflective sheet 18 has high light reflectivity. The reflective sheet 18 effectively reflects some rays of light exiting through the opposite plate surface 17C of the light guide plate 17 toward the front side, that is, toward the light exiting surface 17B.

As illustrated in FIGS. 1 and 3, the optical sheets 19 have surfaces parallel to the plate surfaces of the liquid crystal panel 11 and the light guide plate 17. The surfaces of the optical sheets 19 include long sides that extend in the X-axis direction and short sides that extend in the Y-axis direction. A thickness direction of the optical sheets 19, which is a normal direction to the surfaces of the optical sheets 19, matches the Z-axis direction. The optical sheets 19 are disposed between the liquid crystal panel 11 and the light guide plate 17 with respect to the Z-axis direction. The optical sheets 19 are between the back side surface of the liquid crystal panel 11 and the light exiting surface 17B of the light guide plate 17. The optical sheets 19 exert optical effects on the light that exit through the light exiting surface 17B of the light guide plate 17 and directs the light toward the liquid crystal panel 11. The optical sheets 19 of this embodiment include three sheets including a diffusing sheet, a prism sheet for collecting light, and a reflective polarizing sheet.

As illustrated in FIGS. 1 and 3, the chassis 14 has a shallow tray shape that opens toward the front side. The chassis 14 includes a bottom portion 14A, side portions 14B, and a projection portion 14C. The bottom portion 14A has a rectangular shape similar to the liquid crystal panel 11 and the light guide plate 17. The side portions 14B extend upward and toward the front side from outer edges of the bottom portion 14A. The projection portion 14C projects from a portion of the side portion 14B to be opposed to the bottom portion 14A. The bottom portion 14A has front and rear surfaces and the front surface is defined as a bottom portion front surface 14A1. The reflective sheet 18 and the LED substrate 16 are disposed on the bottom portion front surface 14A1. The light guide plate 17 is disposed on the reflective sheet 18 and the LED substrate 16. The optical sheets 19 are disposed on the light guide plate 17.

As illustrated in FIG. 1, the side portions 14B are on the four outer edges of the bottom portion 14A, respectively. One of the side portions 14B that is opposed to the LEDs 15 is defined as an LED side portion 14B1. The LED side portion 14B1 and the light guide plate 17 sandwich the LEDs 15 therebetween. As illustrated in FIG. 3, the LED side portion 14B1 is disposed to be opposed to opposite surfaces 15D of the side surfaces of the LEDs 15 that are opposite surfaces of the light emitting surfaces 15A. The LED side portion 14B1 is spaced from the opposite surfaces 15D. The projection portion 14C is continuous to the LED side portion 14B1. The projection portion 14C projects from an extending end of the LED side portion 14B1 toward the light guide plate 17 in the Y-axis direction. The rear side surface of the projection portion 14C is opposed to the front side surface of the bottom portion 14A with a space therebetween. The portion of the light guide plate 17 including the light entering surface 17A is disposed between the bottom portion 14A and the projection portion 14C.

As illustrated in FIG. 3, a reflective tape 21 that is white and has good light reflective properties is disposed between the projection portion 14C and each of the LEDs 15 and the light guide plate 17. The reflective tape 21 is contacted with the rear side surface of the projection portion 14C and the light exiting surface 17B of the light guide plate 17. The light emitted by the LEDs 15 is efficiently reflected by the reflective tape 21 and this improves light entrance efficiency of light entering through the light entering surface 17A. The LEDs 15 and the LED substrate 16, which are configured as the light source member 20, the portion of the light guide plate 17, and the reflective tape 21 are arranged in a space that is defined by the bottom portion 14A, the LED side portion 14B1, and the projection portion 14C. In the first embodiment, the top surfaces 15C of the LEDs 15 and the light exiting surface 17B of the light guide plate 17 are disposed at different levels with respect to the Z-axis direction; however, the top surfaces 15C of the LEDs 15 and the light exiting surface 17B of the light guide plate 17 may be disposed at the same level with respect to the Z-axis direction. In such a configuration, the reflective tape 21 may be disposed to be contacted with the rear side surface of the projection portion 14C, the top surfaces 15C of the LEDs 15, and the light exiting surface 17B of the light guide plate 17.

A detailed configuration of the connection member 30 will be described with reference to FIGS. 1 to 3. The connection member 30 connects the light guide plate 17 and the light source member 20 in an arrangement direction in which the light entering surface 17A of the light guide plate 17 and the light emitting surface 15A of the LED 15, which is a light source, are arranged. In this embodiment, the arrangement direction in which the light entering surface 17A and the light emitting surface 15A are arranged matches the Y-axis direction. The connection member 30 has a rectangular plan view shape that is elongated in the Y-axis direction and is a film member having a thickness of from 0.02 mm to 0.05 mm. The thickness of the connection member 30 may be smaller than 0.02 mm and may be greater than 0.05 mm. The connection member 30 has a surface that is parallel to the opposite plate surface 17C of the light guide plate 17 and the mounting surface 161 of the LED substrate 16. The connection member 30 is disposed between the opposite plate surface 17C and the mounting surface 161 with respect to the Z-axis direction. The length of the connection member 30 measured in the Y-axis direction is slightly smaller than the length of the LED substrate 16 measured in the Y-axis direction. The length may be adjusted as appropriate. For instance, the length of the connection member 30 measured in the Y-axis direction may be about same as the length of the LED substrate 16 measured in the Y-axis direction and may be greater than the length of the LED substrate 16 measured in the Y-axis direction. The connection member 30 is made of material that shrinks under a predefined condition. In this embodiment, the connection member 30 is made of heat shrink material that shrinks by heat and keeps the state after the shrinkage. Examples of the heat shrink material necessarily have heat shrink properties and may include polyethylene terephthalate, polystyrene, polypropylene, and polyethylene.

The connection member 30 has a front surface 301 on the front side and a rear surface 302 that is an opposite surface of the front surface 301. An end portion of the front surface 301 close to the light guide plate 17 in the Y-axis direction overlaps the opposite plate surface 17C of the light guide plate 17 from the rear side. A double-sided adhesive tape 31 is attached to the end portion of the front surface 301. As illustrated in FIG. 3, with the double-sided adhesive tape 31, the front surface 301 of the connection member 30 and the overlapping portion of the opposite plate surface 17C of the light guide plate 17 are bonded. A double-sided adhesive tape 32 is attached to an end portion of the rear surface 302 of the connection member 30 that is an opposite end portion of the end portion having the double-sided adhesive tape 31 with respect to the Y-axis direction. As illustrated in FIG. 3, with the double-sided adhesive tape 32, the rear surface 302 of the connection member 30 and the mounting surface 161 of the LED substrate 16 are bonded. Thus, the connection member 30 connects a portion of the opposite plate surface 17C and a portion of the mounting surface 161 of the LED substrate 16.

Next, operations and effects of the backlight unit 12 including the connection members 30 will be described with describing a method of assembling the backlight unit 12. The LEDs 15 are mounted on the LED substrate 16 with variation in position during the manufacturing process. Therefore, the positions of the light emitting surfaces 15A with respect to the optical axis direction (the Y-axis direction) may vary (for instance, about 0.5 mm at most). In assembling the backlight unit 12, with the positions of the light emitting surfaces 15A varying, the LED substrate 16 is disposed on the bottom portion front surface 14A1 of the chassis 14 and under the projection portion 14C with the mounting surface 161 facing upward. The connection members 30 are disposed on the two end portions of the mounting surface 161 of the LED substrate 16 with respect to the X-axis direction. After the rear surfaces 302 of the connection members 30 are bonded to the mounting surface 161 with the double-sided adhesive tapes 32, the LED substrate 16 is disposed on the bottom portion front surface 14A1 of the chassis 14. Or after the LED substrate 16 is disposed on the bottom portion front surface 14A1 of the chassis 14, the rear surfaces 302 of the connection members 30 may be bonded to the two end portions of the mounting surface 161 in the X-axis direction with the double-sided adhesive tapes 32. Then, the reflective sheet 18 is disposed on the portion of the bottom portion front surface 14A1 where the LED substrate 16 is not disposed.

The light guide plate 17 is disposed on the LED substrate 16 and the reflective sheet 18 such that the light entering surface 17A is inserted between the LED substrate 16 and the projection portion 14C. In this process, the front surface 301 of the connection member 30 is bonded to the portion of the opposite plate surface 17C of the light guide plate 17 that is close to the light entering surface 17A with the double-sided adhesive tape 31. Thus, the connection member 30 connects the portion of the opposite plate surface 17C and the portion of the mounting surface 161 of the LED substrate 16.

As previously described, when the distance between the light entering surface 17A and the light emitting surfaces 15A of the LEDs 15 is zero and the light entering surface 17A is contacted with the light emitting surfaces 15A, the light entrance efficiency is highest. However, if there is variation in position of the light emitting surfaces 15A of the LEDs 15, the light entering surface 17A may not be contacted with the light emitting surfaces 15A of some of the LEDs 15 and a gap G1 may be created between the light entering surface 17A and the light emitting surfaces 15A. The light guide plate 17 may expand and shrink repeatedly due to the change of environment temperature and the position of the light entering surface 17A with respect to the Y-axis direction may be changed. If it occurs, the light entering surface 17A may not be contacted with the light emitting surfaces 15A of some of the LEDs 15 and the gap G1 may be created between the light entering surface 17A and the light emitting surfaces 15A of the LEDs 15. The dimension of the gap G1 measured in the Y-axis direction is about 0.5 mm at most.

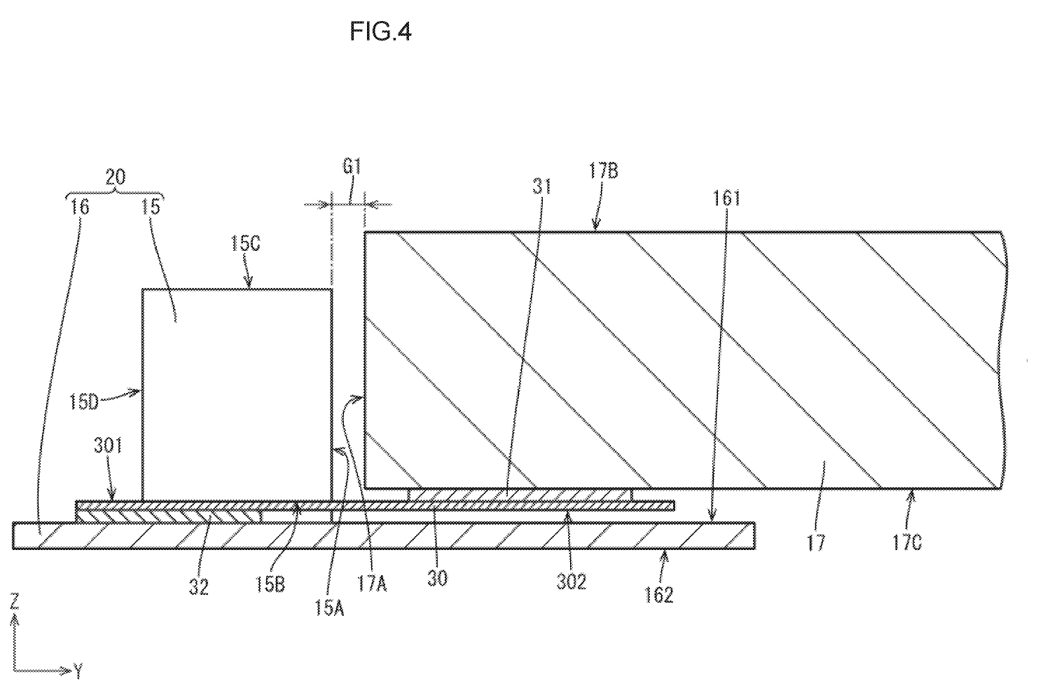

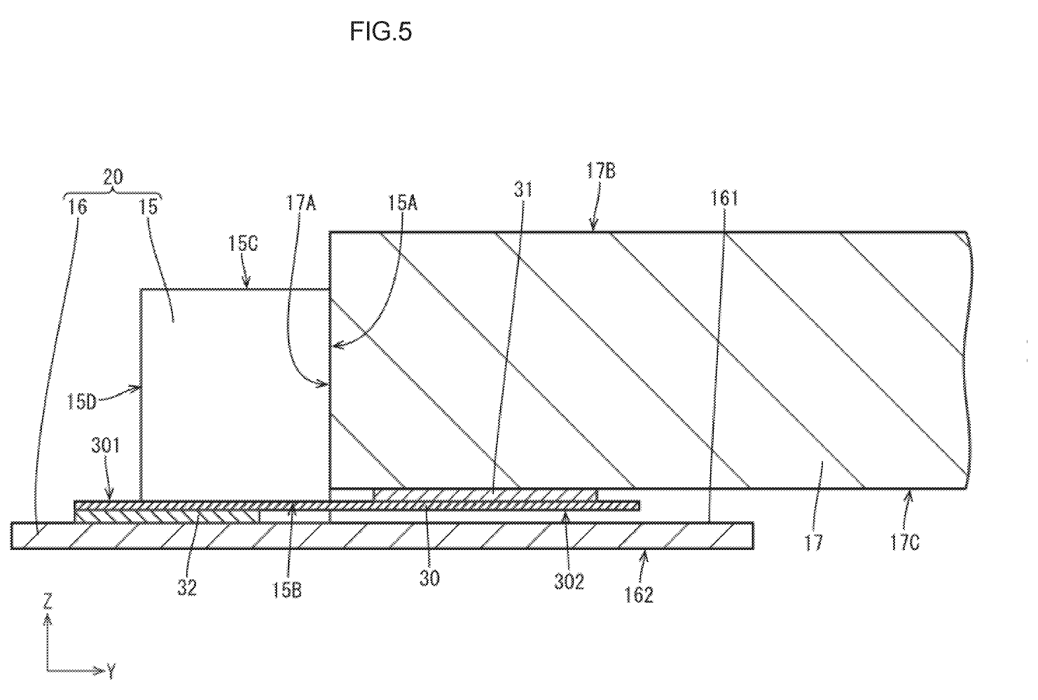

As previously described, the connection members 30 are made of heat shrink material. The connection members 30 are configured such that the light entering surface 17A of the light guide plate 17 and the light emitting surfaces 15A of the LEDs 15 come into contact when the connection members 30 are heated to a predefined temperature or higher and shrink with certain shrinkage. Specifically, the heat shrink material of the connecting members 30 shrinks by about 15% in the length direction when being heated to about 65°C. In the first embodiment, the length of the connection member 30 measured in the Y-axis direction is about 4 mm. In such a configuration, the length of the connection member 30 measured in the Y-axis direction is shortened by about 0.6 mm when the connection member 30 is heated to about 65°C. Therefore, according to the shrink of the connection members 30, the light entering surface 17A and the light emitting surfaces 15A become closer to each other and the gap G1 illustrated in FIG. 4 is reduced. In FIG. 5, there is no gap G1 illustrated in FIG. 4 and the light entering surface 17A and the light emitting surface 15A are contacted with each other.

The LED substrate 16 is a flexible printed circuit (FPC) substrate. Therefore, with the light guide plate 17 and the portion of the LED substrate 16 that is close to the light guide plate 17 being fixed to the chassis 14, the portion of the LED substrate 16 corresponding to the gap G1 can be warped according to the shrinkage of the connection members 30. Accordingly, the contact of the light entering surface 17A and the light emitting surfaces 15A can be maintained. With the LED substrate 16 being not fixed to the chassis 14, according to the shrinkage of the connection members 30, the light entering surface 17A and the light emitting surfaces 15A become closer to each other without warping of the LED substrate 16 and the contact of the light entering surface 17A and the light emitting surfaces 15A can be maintained. With the double-sided adhesive tapes 31, 32 having predefined adhesive properties, the light entering surface 17A and the light emitting surfaces 15A are less likely to push each other excessively when the connection members 30 shrink and the LEDs 15 are less likely to receive stress.

To exert such operations and effects, the operator who assembles the backlight unit 12 heats the connection members 30 with warm air. Accordingly, the connection members 30 shrink and the light entering surface 17A of the light guide plate 17 and the light emitting surfaces 15A of the LEDs 15 mounted on the LED substrate 16 are likely to be contacted with each other. A particular process for the shrink of the connection members 30 such as warming the connection members 30 with warm air may be performed for the shrink of the connection members 30. If the process of producing the backlight unit 12 includes a step in which the unit is exposed to the predefined temperature, the connection members 30 may shrink in the step. After the backlight unit 12 comes onto the market, the backlight unit 12 may be exposed to the predefined temperature according to the environment where the backlight unit 12 is used. The connection members 30 may shrink in such an environment. In such a case, the particular process for the shrink of the connection members 30 may not necessarily included in the process of producing the backlight unit 12. In any of the above cases, the light emitting surfaces 15A of the LEDs 15 and the light entering surface 17A of the light guide plate 17 are likely to be contacted with each other by the shrinkage of the connection members 30.

As previously described, the backlight unit 12 includes the light source member 20 that includes the LEDs 15 and the LED substrate 16 having the LEDS 15 thereon, the light guide plate 17, and the connection members 30. The light guide plate 17 has a plate shape having side surfaces. One of the side surfaces is the light entering surface 17A through which light from the LEDs 15 enters is opposed to the light emitting surfaces 15A of the LEDs 15. The connection members 30 connect the light guide plate 17 and the light source member 20 in the direction that the light entering surface 17A and the light emitting surfaces 15A are arranged. The connection members 30 are made of material that shrinks under a predefined condition.

The light entrance efficiency of the light guide plate 17 improves as the distance between the LEDs 15, which are the light source, and the light entering surface 17A of the light guide plate is shorter and it is most preferable that the distance is zero. However, there may be variation in position of the LEDs 15 that are mounted on the LED substrate 16 during the production of the unit. The light guide plate 17 may expand and shrink repeatedly due to the change of the temperature of the environment where the backlight unit 12 is disposed and the distance between the LEDs 15 and the light entering surface 17A of the light guide plate 17 may change. In the backlight unit 12, the connection members 30 connect the light guide plate 17 and the light source member 20 in the direction that the light entering surface 17A and the light emitting surfaces 15A are arranged. The connection members 30 are made of material that shrinks under a predefined condition. Therefore, even with the gap G1 being created between the light entering surface 17A and the light emitting surfaces 15A of the LEDs 15, the connection members 30 shrink under the predefined condition and the gap G1 is reduced. Therefore, luminance unevenness is suppressed easily and surely in the backlight unit 12.

The light guide plate 17 includes two plate surfaces that are surrounded by the side surfaces. One of the two plate surfaces is the light exiting surface 17B through which the light entering through the light entering surface 17A exits and the other one of the two plate surfaces is the opposite plate surface 17C that is an opposite surface of the light exiting surface 17B. The LED substrate 16 has the mounting surface 161 on which the LEDs 15 are mounted. The mounting surface 161 is opposed to the opposite plate surface 17C. The connection member 30 connects a portion of the opposite plate surface 17C and a portion of the mounting surface 161 of the LED substrate 16.

With such a configuration, even with the gap G1 being created between the light entering surface 17A of the light guide plate 17 and the light emitting surfaces 15A of the LEDs 15, the connection member 30, which connects the portion of the opposite plate surface 17C and the portion of the mounting surface 161 of the LED substrate 16, shrinks under the predefined condition and the light entering surface 17A and the light emitting surfaces 15A become closer to each other and the gap G1 is reduced. Since the opposite plate surface 17C of the light guide plate 17 is opposed to the mounting surface 161 of the LED substrate 16, the light entering surface 17A and the light emitting surfaces 15A that become closer to each other according to the shrinkage of the connection member 30 are likely to be contacted with each other closely. Therefore, luminance unevenness is suppressed in the backlight unit 12.

The LED substrate 16 is a flexible substrate.

Since the LED substrate 16 is a flexible substrate, the LED substrate 16 is warped according to the shrinkage of the connection members 30 and the light entering surface 17A and the light emitting surfaces 15A can be closely contacted with each other.

The connection members 30 are made of heat shrink material and the light entering surface 17A of the light guide plate 17 and the light emitting surfaces 15A of the LEDs 15 are contacted with each other by the shrinkage when the temperature of the connection members 30 reaches a predefined temperature or higher.

The connection members 30 are made of heat shrink material. Therefore, even with the gap G1 being created between the light entering surface 17A of the light guide plate 17 and the light emitting surfaces 15A of the LEDs 15, the connection members 30 shrink when the temperature of the connection members 30 reaches the predefined temperature or higher and the gap G1 is reduced. Therefore, luminance unevenness is easily suppressed in the backlight unit 12.

### Second Embodiment

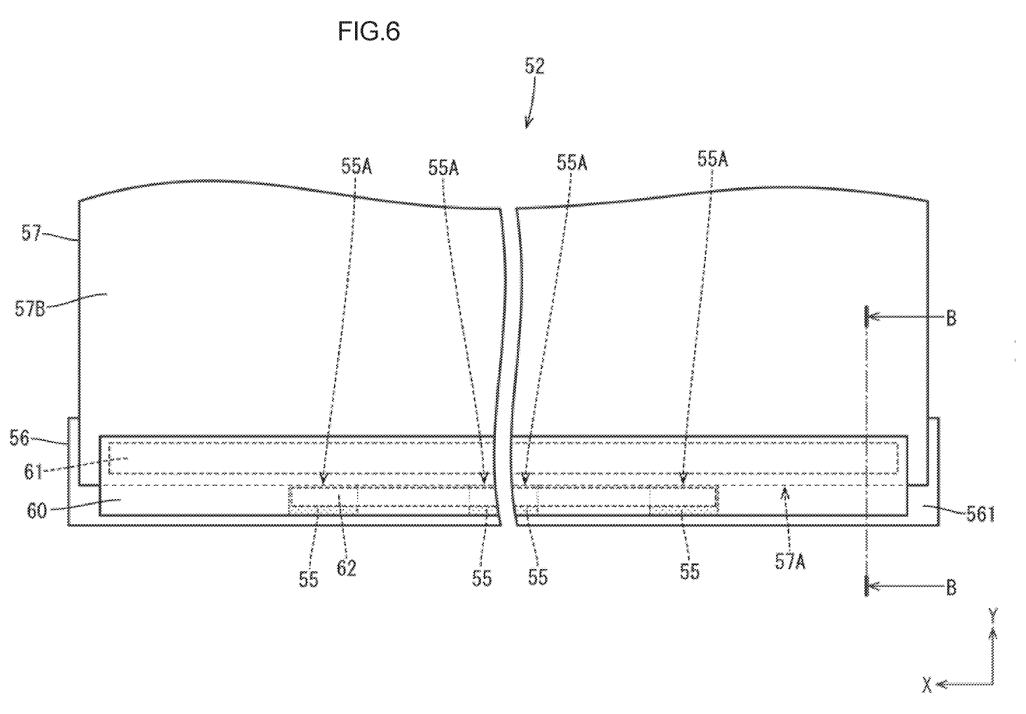

A backlight unit 52 according to a second embodiment will be described with reference to FIGS. 6 to 9. Components of the second embodiment that are same as those of the first embodiment are provided with the same symbols. Configurations, functions, operation, and effects similar to those of the first embodiment will not be described.

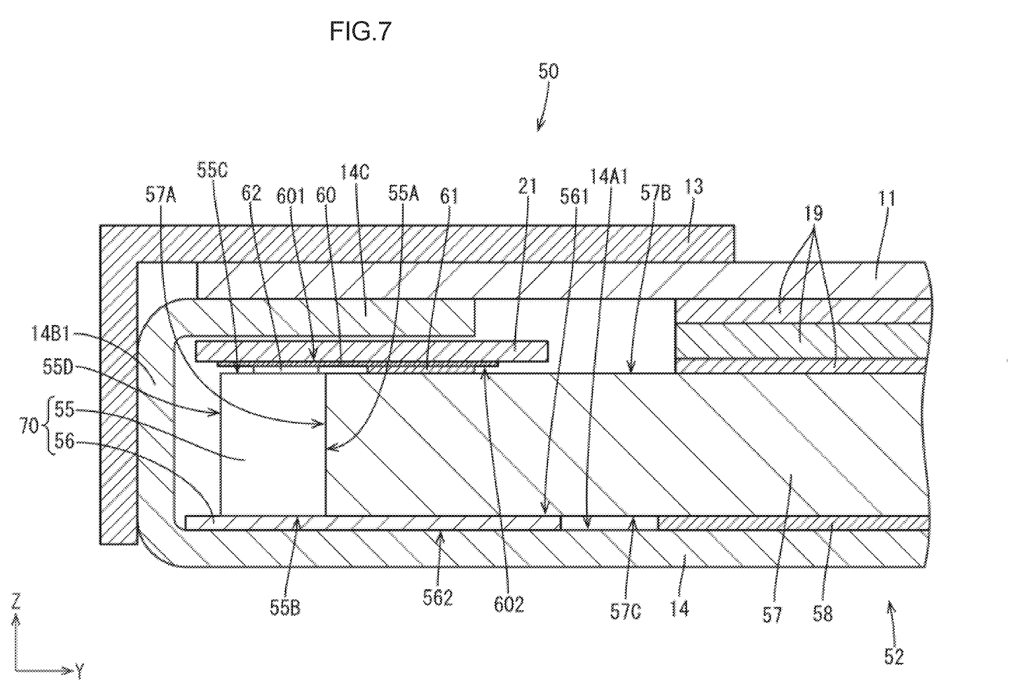

The backlight unit 52 of the second embodiment will be described. As illustrated in FIG. 7, the backlight unit 52 includes the chassis 14, LEDs 55, an LED substrate 56, a light guide plate 57, a reflective sheet 58, the optical sheets 19, and a connection member 60. The LEDs 55 are one example of the light source. The LED substrate 56 is one example of the light source substrate. The light guide plate 57 guides the light from the LEDs 55. The reflective sheet 58 is disposed behind the light guide plate 57. The optical sheets 19 are disposed between the light guide plate 57 and the liquid crystal panel 11. The backlight unit 52 is an edge-lit type backlight in which the light from the LEDs 55 enters the light guide plate 57 through only one of side surfaces of the light guide plate 57.

As illustrated in FIG. 6, the LEDs 55 are arranged along one direction. The direction in which the LEDs 55 are arranged matches the X-axis direction in each drawing. The LEDs 55 are arranged in a straight line at equal intervals in the X-axis direction. The LEDs 55 emit white light as a whole similar to the LEDs 15 of the first embodiment. The chassis 14, the reflective sheet 58, and the optical sheets 19 are not illustrated in FIG. 6.

As illustrated in FIG. 7, the LEDs 55 are side emitting LEDs similar to the LEDs 15 of the first embodiment and include bottom surfaces 55B that are contacted with the LED substrate 56 and light emitting surfaces 55A adjacent to the bottom surfaces 55B. The light emitting surfaces 55A of the LEDs 55 extend parallel to the X-axis direction and the Z-axis direction and a normal direction to the light emitting surface 55A matches the Y-axis direction. An optical axis of each LED 55 is parallel to the Y-axis direction. The LEDs 55 have top surfaces 55C that are adjacent to the light emitting surfaces 55A and opposite surfaces from the bottom surfaces 55B in the Z-axis direction.

The LED substrate 56 is a flexible printed circuit (FPC) substrate similar to the LED substrate 16 of the first embodiment. As illustrated in FIG. 6, the LED substrate 56 has an elongated belt plan view shape extending along the direction in which the LEDs 55 are arranged. As illustrated in FIG. 7, the LED substrate 56 is disposed such that the plate surface thereof is parallel to the surface of the light guide plate 57. The LEDs 55 are mounted on the LED substrate 56. One of the front and rear plate surfaces of the LED substrate 56 facing the front side is defined as a mounting surface 561 on which the LEDs 55 are mounted. Other one of the plate surfaces facing the rear side is defined as a rear surface 562 that is an opposite surface from the mounting surface 561. The mounting surface 561 of the LED substrate 56 faces bottom surfaces 55B of the LEDs 55 and is contacted with the bottom surfaces 55B of the LEDs 55 and faces an opposite plate surface 57C of the light guide plate 57 and is contacted with the opposite plate surface 57C. The rear surface 562 of the LED substrate 56 faces the bottom portion front surface 14A1 of the bottom portion 14A of the chassis 14 and is contacted with the bottom portion front surface 14A1. In the following description, the LEDs 55 and the LED substrate 56 are configured as a light source member 70.

The light guide plate 57 has a configuration similar to that of the light guide plate 17 of the first embodiment. As illustrated in FIGS. 6 and 7, one of side surfaces of the light guide plate 57 along the long edges is defined as a light entering surface 57A. The light entering surface 57A faces the light emitting surfaces 55A of the LEDs 55 and extends along the light emitting surfaces 55A. The light entering surface 57A is a laterally long surface that extends along the X-axis direction and the Z-axis direction. The elongated direction matches the X-axis direction (the direction in which the LEDs 55 are arranged) and the width direction matches the Z-axis direction. The normal direction to the light entering surface 57A matches the Y-axis direction. The light emitted through the light emitting surfaces 55A of the LEDs 55 directly enters the light guide plate 57 through the light entering surface 57A.

As illustrated in FIGS. 6 and 7, one of plate surfaces of the light guide plate 57 on the front side is defined as a light exiting surface 57B. The other one of the plate surfaces of the light guide plate 57 on the back side is defined as the opposite plate surface 57C. The light exiting surface 57B is opposed to the liquid crystal panel 11 and the optical sheets 19. The light exiting surface 57B is at the same level as top surfaces 55C of the LEDs 55. Namely, the light exiting surface 57B extends to be on the same plane as the top surfaces 55C. The light emitted by the LEDs 55 toward the light guide plate 57 enters the light guide plate 57 through the light entering surface 57A and the light travels within the light guide plate 57 and is guided along the Z-axis direction toward the front side (a light exit side) and exits the light guide plate 57.

The reflective sheet 58 effectively reflects some rays of light exiting through the opposite plate surface 57C of the light guide plate 57 toward the light exiting surface 57B similar to the reflective sheet 18 of the first embodiment.

The connection member 60 is for connecting the light guide plate 57 and the light source member 70. The connection member 60 connects the light guide plate 57 and the light source member 70 in an arrangement direction in which the light entering surface 57A of the light guide plate 57 and the light emitting surface 55A of the LED 55, which is a light source, are arranged. The connection member 60 is a film member made of heat shrink material similar to the connection member 30 of the first embodiment. The connection member 60 has a surface that extends parallel to the light exiting surface 57B of the light guide plate 57 and the top surfaces 55C of the LEDs 55. As illustrated in FIG. 7, the connection member 60 is disposed between the reflective tape 21 and each of the light exiting surface 57B and the top surfaces 55C of the LEDs 55 in the Z-axis direction. As illustrated in FIG. 6, the connection member 60 has a rectangular plan view shape that is smaller than the LED substrate 56. The size of the connection member 60 may be altered as appropriate. For instance, the length of the connection member 60 measured in the Y-axis direction may be same as or greater than the length of the LED substrate 56 measured in the Y-axis direction.

The connection member 60 includes a front surface 601 on the front side and a rear surface 602 that is an opposite surface of the front surface 601. An end portion of the rear surface 602 close to the light guide plate 57 in the Y-axis direction overlaps the light exiting surface 57B of the light guide plate 57 from the front side. A double-sided adhesive tape 61 is attached to the end portion of the rear surface 602. As illustrated in FIG. 7, with the double-sided adhesive tape 61, the rear surface 602 of the connection member 60 and the overlapping portion of the light exiting surface 57B of the light guide plate 57 are bonded. A double-sided adhesive tape 62 is attached to an end portion of the rear surface 602 of the connection member 60 that is an opposite end portion of the end portion having the double-sided adhesive tape 61 with respect to the Y-axis direction. As illustrated in FIG. 6, the double-sided adhesive tape 62 extends in the X-axis direction so as to be disposed on the entire area where the LEDs 55 are arranged in the X-axis direction. Namely, the double-sided adhesive tape 62 is disposed on the top surfaces 55C of the LEDs 55. As illustrated in FIG. 7, with the double-sided adhesive tape 62, the rear surface 602 of the connection member 60 and the top surfaces 55C of the LEDs 55 that are mounted on the LED substrate 56 are bonded. Thus, the connection member 60 connects a portion of the light exiting surface 57B and the top surfaces 55C of the LEDs 55.

Next, operations and effects of the backlight unit 52 including the connection member 60 will be described with describing a method of assembling the backlight unit 52. The LEDs 55 are mounted on the LED substrate 56 with variation in position during the manufacturing process. Therefore, the position of the light emitting surface 55A with respect to the optical axis direction (the Y-axis direction) may vary (for instance, about 0.5 mm at most). In assembling the backlight unit 52, with the position of the light emitting surface 55A varying, the LED substrate 56 is disposed on the bottom portion front surface 14A1 of the chassis 14 and under the projection portion 14C with the mounting surface 561 facing upward. At this time, the double-sided adhesive tape 62 is disposed to extend over the top surfaces 55C of the LEDs 55. The reflective sheet 58 is disposed on the portion of the bottom portion front surface 14A1 where the LED substrate 56 is not disposed.

The light guide plate 57 is disposed on the LED substrate 56 and the reflective sheet 58 such that the light entering surface 57A is inserted between the LED substrate 56 and the projection portion 14C. In this process, the double-sided adhesive tape 61 is disposed on the portion of the light exiting surface 57B of the light guide plate 57 close to the light entering surface 57A. Next, the connection member 60 is inserted between the projection portion 14C and each of the light exiting surface 57B and the top surfaces 55C of the LEDs 55 and is disposed on the light exiting surface 57B and the top surfaces 55C of the LEDs 55. In this process, the rear surface 602 of the connection member 60 is bonded to the portion of the light exiting surface 57B of the light guide plate 57 that is close to the light entering surface 57A with the double-sided adhesive tape 61. The rear surface 602 of the connection member 60 is bonded to the top surfaces 55C of the LEDs 55 with the double-sided adhesive tape 62. Thus, the connection member 60 connects the portion of the light exiting surface 57B and the top surfaces 55C of the LEDs 55.

Similar to the first embodiment, when the distance between the light entering surface 57A and the light emitting surfaces 55A of the LEDs 55 is zero and the light entering surface 57A is contacted with the light emitting surfaces 55A, the light entrance efficiency is highest. However, if there is variation in position of the light emitting surfaces 55A of the LEDs 55, the light entering surface 57A may not be contacted with the light emitting surfaces 55A of some of the LEDs 55 and a gap G2 may be created between the light entering surface 57A and the light emitting surfaces 55A. The light guide plate 57 may expand and shrink repeatedly due to the change of environment temperature and the position of the light entering surface 57A with respect to the Y-axis direction may be changed. If it occurs, the light entering surface 57A may not be contacted with the light emitting surfaces 55A of some of the LEDs 55 and the gap G2 may be created between the light entering surface 57A and the light emitting surfaces 55A of the LEDs 55. The dimension of the gap G2 measured in the Y-axis direction is about 0.5 mm at most similar to the first embodiment.

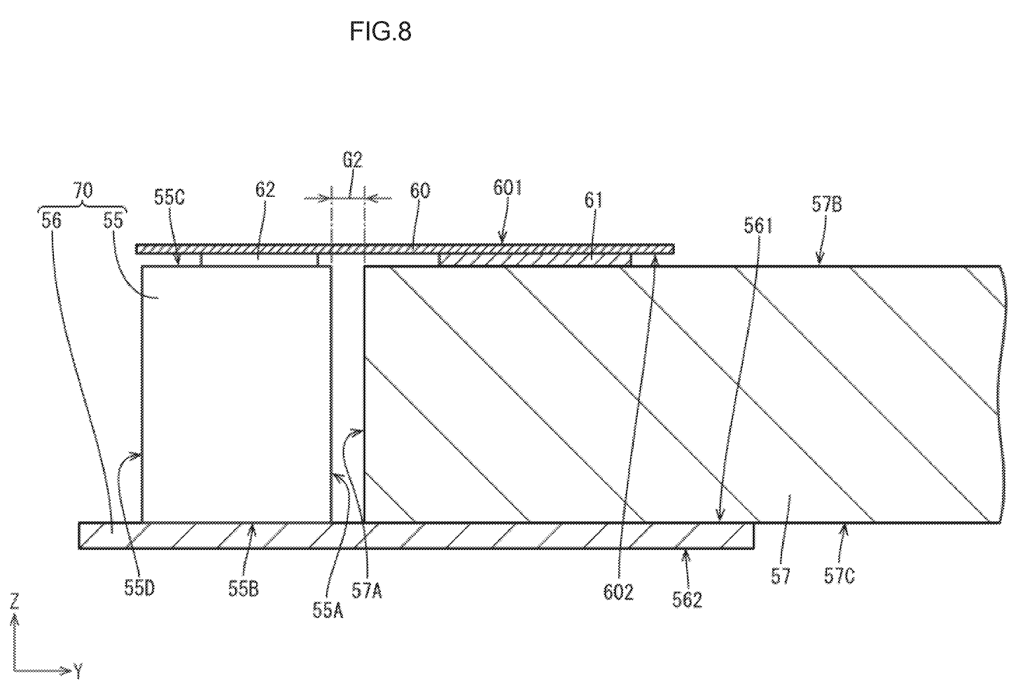

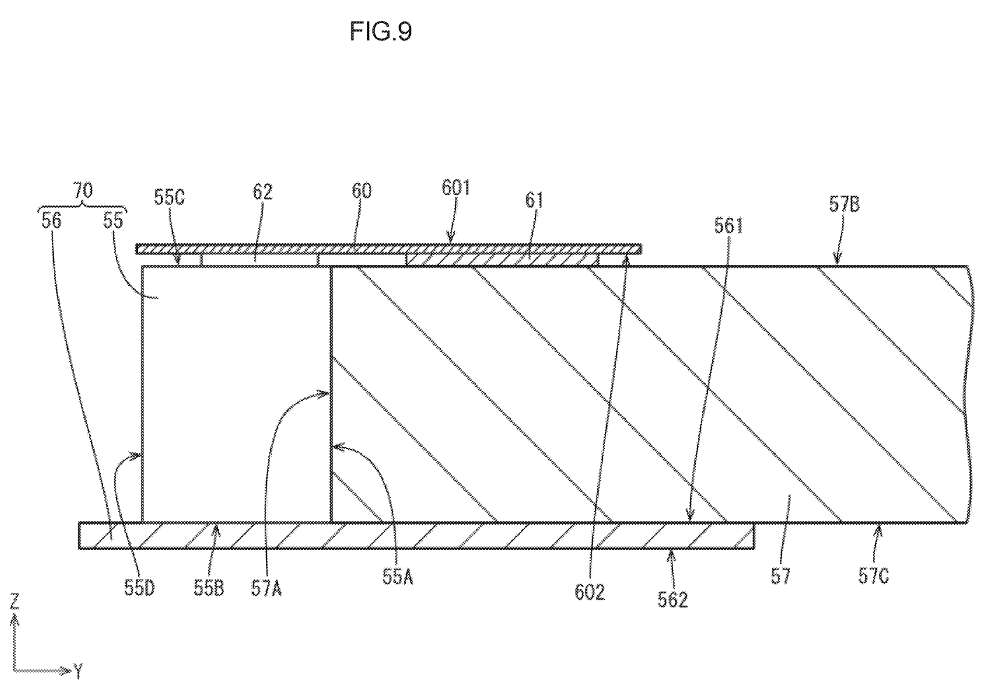

As previously described, the connection member 60 is made of heat shrink material. The connection member 60 is configured such that the light entering surface 57A of the light guide plate 57 and the light emitting surfaces 55A of the LEDs 55 come into contact with each other when the connection member 60 is heated to a predefined temperature or higher and shrink with certain shrinkage. Similar to the first embodiment, the heat shrink material of the connecting member 60 shrinks by about 15% in the length direction when being heated to about 65°C. The length of the connection member 60 measured in the Y-axis direction is about 4 mm. In such a configuration, the length of the connection member 60 measured in the Y-axis direction is shortened by about 0.6 mm when the connection member 60 is heated to about 65°C. Therefore, according to the shrinkage of the connection member 60, the light entering surface 57A and the light emitting surfaces 55A become closer to each other and the gap G2 illustrated in FIG. 8 is reduced. In FIG. 9, there is no gap G2 illustrated in FIG. 8 and the light entering surface 57A and the light emitting surface 55A are contacted with each other.

The LED substrate 56 is a flexible printed circuit (FPC) substrate. Therefore, with the light guide plate 57 and the portion of the LED substrate 56 that is close to the light guide plate 57 being fixed to the chassis 14, the portion of the LED substrate 56 corresponding to the gap G2 can be warped according to the shrinkage of the connection member 60. Accordingly, the contact of the light entering surface 57A and the light emitting surfaces 55A can be maintained. With the LED substrate 56 being not fixed to the chassis 14, according to the shrinkage of the connection member 60, the light entering surface 57A and the light emitting surfaces 55A become closer to each other without warping of the LED substrate 56 and the contact of the light entering surface 57A and the light emitting surfaces 55A can be maintained. With the double-sided adhesive tapes 61, 62 having predefined adhesive properties, the light entering surface 57A and the light emitting surfaces 55A are less likely to push each other excessively when the connection member 60 shrinks and the LED substrate 56 and the LEDs 55 are less likely to receive stress. In the second embodiment, the light exiting surface 57B of the light guide plate 57 and the top surfaces 55C of the LEDs 55 extend on the same plane surface. With such a configuration, according to the shrinkage of the connection member 60, the light entering surface 57A of the light guide plate 57 and the light emitting surfaces 55A of the LEDs 55 are likely to become closer to each other with the light entering surface 57A and the light emitting surfaces 55A being on the same plane surface. Therefore, the light entering surface 57A and the light emitting surfaces 55A are likely to be closely contacted with each other by the shrinkage of the connection member 60.

To exert such operations and effects, the operator who assembles the backlight unit 52 heats the connection member 60 with warm air. Accordingly, the connection member 60 shrinks and the light entering surface 57A of the light guide plate 57 and the light emitting surfaces 55A of the LEDs 55 mounted on the LED substrate 56 are likely to be contacted with each other. A particular process for the shrink of the connection member 60 such as warming the connection member 60 with warm air may be performed for the shrink of the connection member 60. If the process of producing the backlight unit 52 includes a step in which the unit is exposed to the predefined temperature, the connection member 60 may shrink in the step. After the backlight unit 52 comes onto the market, the backlight unit 52 may be exposed to the predefined temperature according to the environment where the backlight unit 52 is used. The connection member 60 may shrink in such an environment. In any of the above cases, the light emitting surfaces 55A of the LEDs 55 and the light entering surface 57A of the light guide plate 57 are likely to be contacted with each other by the shrinkage of the connection member 60.

As previously described, in the backlight unit 52, the light guide plate 57 includes the light exiting surface 57B as a plate surface that is surrounded by the side surfaces of the light guide plate 57. Light entering through the light entering surface 57A exits the light guide plate 57 through the light exiting surface 57B. The LED 55, which is the light source, includes the bottom surface 55B and the top surface 55C that are adjacent to the light emitting surface 55A. The LED 55 is mounted on the LED substrate 56 with the bottom surface 55B. The connection member 60 connects a portion of the light exiting surface 57B and the top surface 55C of the LED 55.

With the above configuration, even with the gap G2 being created between the light entering surface 57A of the light guide plate 57 and the light emitting surfaces 55A of the LEDs 55, the connection member 60, which connects the portion of the light exiting surface 57B and the top surface 55C of the LED 55, shrinks under the predefined condition and the gap G2 is reduced. Therefore, luminance unevenness is suppressed in the backlight unit 52.

The light exiting surface 57B extends on the same plane as the top surfaces 55C.

The light exiting surface 57B of the light guide plate 57 and the top surfaces 55C of the LEDs 55 extend on the same plane surface. Therefore, according to the shrinkage of the connection member 60, the light entering surface 57A and the light emitting surfaces 55A are likely to be closely contacted with each other by the shrinkage of the connection member 60.

The liquid crystal display device 10, 50 includes the backlight unit 12, 52, and the liquid crystal panel 11 that displays an image with using light supplied by the backlight unit 12, 52.

With the display device having such a configuration, luminance unevenness of the backlight unit 12, 52 that supplies light to the liquid crystal panel 11 is suppressed and the quality of the liquid crystal display device 10, 50 can be maintained.

### Other Embodiments

The technology described herein is not limited to the embodiments described in this specification and illustrated in the drawings. For example, the following embodiments may be included in the technical scope of the present invention.
(1) The LED substrate 16, 56 may be a rigid substrate having no flexibility. Even with such a configuration, the light entering surface 17A, 57A of the light guide plate 17, 57 and the light emitting surfaces 15A, 55A of the LEDs 15, 55 mounted on the LED substrate become closer to each other according to the shrinkage of the connection member 30, 60 under a predefined condition and the gap G1, G2 between the light entering surface 17A, 57A and the light emitting surfaces 15A, 55A is reduced.
(2) The connection member 30, 60 may be made of various kinds of materials that shrink under a condition other than heating such as material that shrinks by light and keeps the state after the shrinkage.
(3) In the first embodiment, the connection members 30 are not necessarily disposed on the two end portions of the LED substrate 16 in the X-axis direction. For instance, the connection members 30 may be disposed between the LEDs 15.
(4) In the second embodiment, the connection member 60 is disposed to extend over the top surfaces 55C of the LEDs 55. Multiple connection members 60 each of which connects the top surface 55C of each LED 55 and a portion of the light exiting surface 57B may be included corresponding to the number of LEDs 55.
(5) The size of the LED substrate 16, 56, the intervals and the number of LEDs 15, 55 may be altered as appropriate according to the screen size, the usage, and the required accuracy of the liquid crystal panel 11. The LED substrate 16, 56 may be disposed on the light guide plate 17, 57 and the LEDs 15, 55 may be mounted on the LED substrate 16, 56 so as to project downward from the LED substrate 16, 56. In such a configuration, with the connection member 30, 60 connecting the light guide plate 17, 57 and the light source member 20, 70 in the direction that the light entering surface 17A, 57A of the light guide plate 17, 57 and the light emitting surfaces 15A, 55A of the LEDs 15, 55 on the LED substrate 16, 56 are arranged, the gap between the light entering surface 17A, 57A and the light emitting surfaces 15A, 55A is reduced.
(6) The connection member 30, 60 may be disposed such that a predefined gap is between the light emitting surfaces 15A, 55A of all the LEDs 15, 55 and the light entering surface 17A, 57A of the light guide plate 17, 57. In such a configuration, luminance unevenness can be effectively suppressed as long as the predefined gap between the light emitting surfaces 15A, 55A and the light entering surface 17A, 57A of the light guide plate 17, 57 becomes a constant gap when the connection member 30, 60 shrinks. The LEDs 15, 55 may include LEDs whose light emitting surfaces 15A, 55A are contacted with the light entering surface 17A, 57A and LEDs whose light emitting surfaces 15A, 55A are not contacted with the light entering surface 17A, 57A.
(7) The light emitting surfaces 15A, 55A of the LEDs 15, 55 may not be necessarily flat surfaces illustrated in the drawings but may be spherical surfaces or curved surfaces.
(8) The top surfaces 15C, 55C of the LEDs 15, 55 may not be necessarily flat surfaces illustrated in the drawings but may be spherical surfaces or curved surfaces. In the second embodiment, at least a portion of the top surface 55C of the LED 55 is preferably on the same plane as the light exiting surface 57B of the light guide plate 57 in the Z-axis direction.
(9) One of side surfaces of the light guide plate 17, 57 along the short edges may be defined as a light entering surface. The LEDs 15, 55 may be arranged such that light enters the light guide plate through multiple light entering surfaces. For instance, with the backlight unit being a two-edge-lit type backlight, the components may be arranged such that the connection member 30, 60 connects the light guide plate 17, 57 and the light source member 20, 70 in the direction that the light entering surface 17A, 57A of the light guide plate 17, 57 and the light emitting surfaces 15A, 55A of the LEDs 15, 55, which are arranged along the light entering surface 17A, 57A, are arranged. Another connection member may be included for connecting another light entering surface of the light guide plate and the light source member including LEDs, which are arranged along the other light entering surface, in a direction that the other light entering surface and light emitting surfaces of the LEDs are arranged.
(10) Other than the above embodiments, the number, the kinds, and the layered order of optical sheets 19 may be altered as appropriate. For instance, the number of optical sheets may be one, two, four or more.
(11) The reflective sheet 18, 58 that covers the opposite plate surface 17C, 57C of the light guide plate 17, 57 may not be included.
(12) The LEDs 55 may not be white LEDs but may be a light source that emits primary light such as a blue LED. In such a configuration, a wavelength conversion sheet that emits light of a complementary color may be preferably included according to a wavelength region of the primary light.
(13) A light source other than the LEDs such as organic EL may be used.
(14) In the above embodiments, the liquid crystal display device including the liquid crystal panel 11 as a display panel is described. However, the present technology may be applied to a MEMS display device that includes a micro electro mechanical system (MEMS) panel as a display panel.
(15) The liquid crystal panel 11 may have plan view shapes such as vertically long rectangular, square, circular, semicircular, oval, or trapezoidal shapes.

1. A lighting device comprising:
a light source member including a light source and a light source substrate on which the light source is mounted;
a light guide plate having side surfaces including a light entering surface through which light from the light source enters, the light entering surface being opposed to a light emitting surface of the light source; and
a connection member that connects the light guide plate and the light source member in a direction that the light entering surface and the light emitting surface are arranged, the connection member being made of material that shrinks under a predefined condition.

2. The lighting device according to claim 1, wherein
the light guide plate includes two plate surfaces that are surrounded by the side surfaces,
the two plate surfaces include a light exiting surface through which the light entering through the light entering surface exits and an opposite plate surface that is an opposite surface of the light exiting surface,
the light source substrate has a mounting surface on which the light source is mounted and the mounting surface is opposed to the opposite plate surface, and
the connection member connects a portion of the opposite plate surface and a portion of the mounting surface of the light source substrate.

3. The lighting device according to claim 1, wherein
the light guide plate includes a light exiting surface through which the light entering through the light entering surface exits and the light exiting surface is a plate surface that is surrounded by the side surfaces,
the light source has a bottom surface and a top surface that are adjacent to the light emitting surface and the bottom surface is on the light source substrate, and
the connection member connects a portion of the light exiting surface and the top surface of the light source.

4. The lighting device according to claim 3, wherein the light exiting surface of the light guide plate extends on a same plane as the top surface.

5. The lighting device according to claim 1, wherein the light source substrate is a flexible substrate.

6. The lighting device according to claim 1, wherein
the connection member is made of heat shrink material, and
the light entering surface of the light guide plate and the light emitting surface of the light source are in contact with each other with shrinkage of the connection member that is heated to a predefined temperature or higher.

7. A display device comprising:
the lighting device according to claim 1; and
a display panel displaying an image with using the light from the lighting device.
